(19) United States
(12) Patent Application Publication
(10) Pub. No.: US 2016/0371543 A1
(43) Pub. Date: Dec. 22, 2016

(54) CLASSIFYING DOCUMENT IMAGES BASED ON PARAMETERS OF COLOR LAYERS

(71) Applicant: ABBYY Development LLC, Moscow (RU)

(72) Inventor: Anatoly Smirnov, Moscow (RU)

(21) Appl. No.: 14/855,707

(22) Filed: Sep. 16, 2015

(30) Foreign Application Priority Data
Jun. 16, 2015 (RU) 2015123026

(51) Int. Cl. G06K 9/00; G06T 7/40; G06K 9/66; G06K 9/46; G06K 9/18

(52) U.S. Cl. CPC G06K 9/00456; G06K 9/4652; G06K 9/18; G06K 9/66; G06T 7/408; G06T 2207/10024

(57) ABSTRACT

Systems and methods for classifying document images using color layer information. An example method comprises: receiving, by a processing device, a document image; determining values of one or more parameters of the document image, wherein at least one parameter is evaluated by extracting one or more color layers of the document image; and associating, based on the values of the parameters, the document image with a category of a plurality of categories.

### CROSS REFERENCE TO RELATED APPLICATIONS

The present application claims the benefit of priority under 35 USC 119 to Russian Patent Application No. 2015123026, filed Jun. 16, 2015; the disclosure of which is incorporated herein by reference.

### TECHNICAL FIELD

The present disclosure is generally related to computer systems, and is more specifically related to systems and methods for processing electronic documents.

### BACKGROUND

An electronic document may be produced by scanning or otherwise acquiring an image of a paper document and performing optical character recognition to produce the text associated with the document.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of one embodiment of a computer system operating in accordance with one or more aspects of the present disclosure;

FIG. 2 schematically illustrates an image of a paper document that may be classified in accordance with one or more aspects of the present disclosure;

FIG. 3 depicts a flow diagram of an illustrative example of a method for processing example images with known classification for training the classifier, in accordance with one or more aspects of the present disclosure;

FIG. 4 depicts a flow diagram of an illustrative example of a method for document image classification, in accordance with one or more aspects of the present disclosure; and

FIG. 5 depicts a more detailed diagram of an illustrative example of a computer system implementing the methods described herein.

### DETAILED DESCRIPTION

Described herein are methods and systems for classifying document images based on parameters of color layers.

“Electronic document” herein shall refer to a file comprising one or more digital content items that may be visually rendered to provide a visual representation of the electronic document (e.g., on a display or a printed material). An electronic document may be produced by scanning or otherwise acquiring an image of a paper document. In various illustrative examples, electronic documents may conform to certain file formats, such as PDF, PDF/A, JPEG, JPEG 2000, JBIG2, BMP, DjVu, EPub, DOC, ODT, etc.

“Computer system” herein shall refer to a data processing device having a general purpose processor, a memory, and at least one communication interface. Examples of computer systems that may employ the methods described herein include, without limitation, desktop computers, notebook computers, tablet computers, and smart phones.

An optical character recognition (OCR) system may acquire an image of a paper document and transform the image into a computer-readable and searchable format comprising the textual information extracted from the image of the paper document. In various illustrative examples, an original paper document may comprise one or more pages, and thus the document image may comprise images of one or more document pages. In the following description, “document image” shall refer to an image of at least a part of the original document (e.g., a document page).

In various illustrative examples, paper documents may come in a wide variety of types, such as books, journal articles, written contracts, hand-written or printed letters on corporate or personal letterhead, personal identification documents such as driving licenses, etc. A paper document may comprise a mixed content including hand-written or printed textual content (such as standalone characters, groups of characters, words, text columns, whole or partial pages or text fragments such as dialog bubbles associated with graphical content), which may be recognized using, for example, an optical character (OCR) recognition system, and graphical content (such as illustrations, photographs, or other graphical elements such as logotypes).

Certain business processes may involve classifying various paper documents into several pre-defined categories. In an illustrative example, an insurance underwriting workflow may assess both eligibility of the customer and certain parameters of the asset to be insured. The workflow may involve extracting certain information from multiple paper-based documents of various types, including contracts, photographs, cache receipts, letters, etc. Some of those documents may be known to have certain pre-determined features, such as seals of certain color that may comprise certain text, certain logotypes, letterhead elements, and/or other visual elements that may, even for black-and-white documents, come in different colors. In an illustrative example, a letter may comprise black-and-white text printed on a color letterhead. In another illustrative example, a contract may comprise a black-and-white text and a color imprint of a seal comprising a certain text string. The underwriting workflow may involve classifying incoming documents into certain categories that may be defined based on certain document features. The document features may be represented by values of certain parameters of document images.

A computer system implementing the methods described herein may acquire a document image and evaluate a plurality of pre-defined parameters of the image. In certain implementations, one or more parameters of the image may be evaluated by extracting one or more color layers from a color map representation of the image (e.g., in HSV color space or an YCbCr color space). Examples of such parameters include: presence of one or more certain colors in the image, the ratio of the number of pixels of one or more certain colors to the total number of pixels within the image, the ratio of the image area overlapped by a certain color layer to the total image area, presence of any text in a certain color layer, and/or presence of a certain text in a certain color layer. A color layer herein is a graphic layer comprising one or more colors. The layer may be extracted from the document image using one of well-known methods, for example, by representing the image in a color space (such as YCbCr, HSV and so on) and applying a color filter.

Estimated parameters may be binary type or range type. Binary parameters reflect the fact of presence or absence of a particular parameter in the document image, for example as “YES”/“NO” or “0”/“1”. The examples of the binary parameters are presence of one or more of predetermined colors in the image, presence of text in a certain color layer, presence of a predetermined text in a certain color layer, etc. The presence of one or more colors may be evaluated by detecting whether they have been extracted from the document image. Presence of any text in a layer may be found using, for example, document layout analysis. To detect whether the color layer includes any certain text, in one implementation, a character recognition method (such as OCR) may be used. In another implementation, any other methods able to detect whether the text under consideration is a certain text may be applied. As for range parameters, various thresholds for pre-determined parameters may be set by a user, by the system, or otherwise. For example, threshold values for parameter “the ratio of the image area overlapping with a certain color layer to the total image area” may be set in ranges: 0 . . . 1; and greater than 1. As one of ordinary skill in the art will appreciate, ranges may differ based on parameter and its function.

Based on the parameter values, the computer system implementing the methods described herein may associate the document image with a certain category of a plurality of categories. In certain implementations, the incoming document images may be categorized based on the presence in the document image of one or more pre-defined objects having certain colors. In various illustrative examples, such objects may be represented by an imprint of a certain seal, a text, a certain text, or a certain graphical element (such as a letterhead element, a visual separator, a logotype, a watermark, or the like). In certain implementations, associating the document image with a category of a plurality of categories may be followed by categorizing the original document. If the document image is a page of an original single page document, the document may be automatically categorized based on the category of its image. In case the document image is a page of an original multiple page document, the document may be associated with a category based on one or more categories of the images of its pages.

In certain implementations, the computer system implementing the methods described herein may utilize a classification function for identifying the category to be associated with the document image. The value of such a function may reflect the degree of association of the document image with a certain category of the plurality of categories (e.g., the probability of the document image being associated with a certain category). The computer system may evaluate the chosen function for each category of the plurality of categories, and then associate the document image with the category corresponding to the optimal value of the classification function.

In certain implementations, in estimating the degree of association of the document image with a certain category of the plurality of categories, the classification function may take into account a pre-existing evidence data set correlating document image parameters and document image categories. In an illustrative example, the computer system implementing the methods described herein may create and/or update the evidence data set by processing a plurality of example images with known classification. For each example image, the computer system may evaluate the image parameters and store the determined parameter values in association with the identifier of the category to which the example image pertains. Alternatively, the computer system implementing the methods described herein may receive the evidence data set from an external source (e.g., from another computer system).

Various aspects of the above referenced methods and systems are described in details herein below by way of examples, rather than by way of limitation.

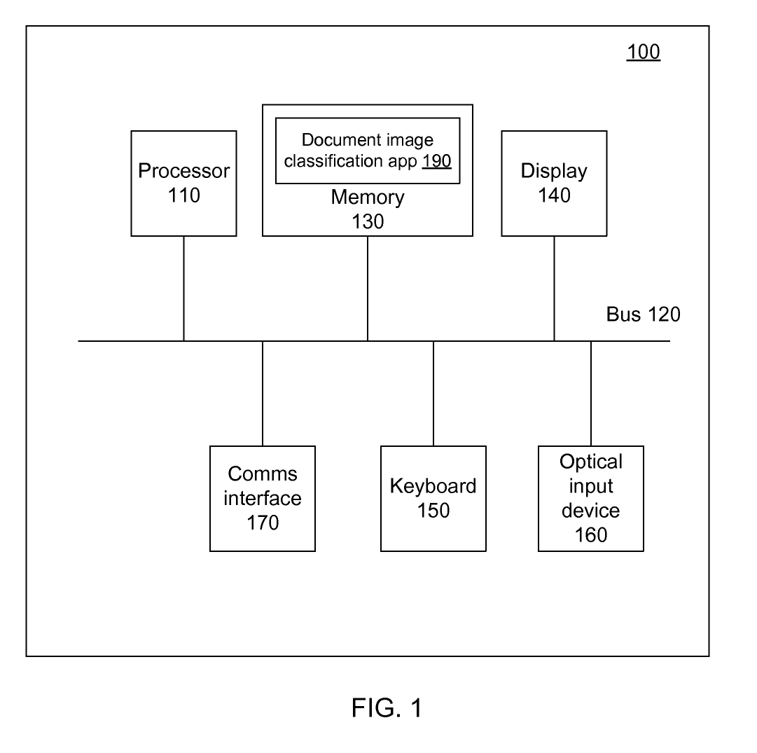

FIG. 1 depicts a block diagram of one illustrative example of a computer system 100 operating in accordance with one or more aspects of the present disclosure. In illustrative examples, computer system 100 may be provided by various computer systems including a tablet computer, a smart phone, a notebook computer, or a desktop computer.

Computer system 100 may comprise a processor 110 coupled to a system bus 120. Other devices coupled to system bus 120 may include a memory 130, a display 140, a keyboard 150, an optical input device 160, and one or more communication interfaces 170. The term “coupled” herein shall refer to being electrically connected and/or communicatively coupled via one or more interface devices, adapters and the like.

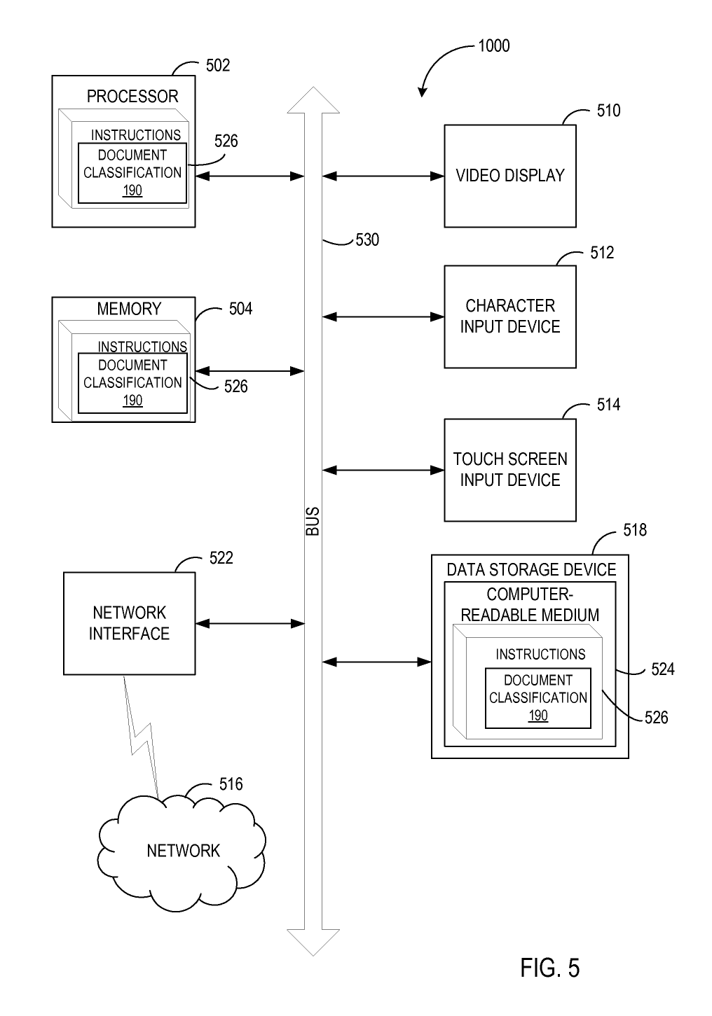

In various illustrative examples, processor 110 may be provided by one or more processing devices, such as general purpose and/or specialized processors. Memory 130 may comprise one or more volatile memory devices (for example, RAM chips), one or more non-volatile memory devices (for example, ROM or EEPROM chips), and/or one or more storage memory devices (for example, optical or magnetic disks). Optical input device 160 may be provided by a scanner or a still image camera configured to acquire the light reflected by the objects situated within its field of view. An example of a computer system implementing aspects of the present disclosure will be discussed in more detail below with reference to FIG. 5.

Memory 130 may store instructions of application 190 for classifying document images using color layer information. In an illustrative example, application 190 may be implemented as a function to be invoked via a user interface of another application. Alternatively, application 190 may be implemented as a standalone application.

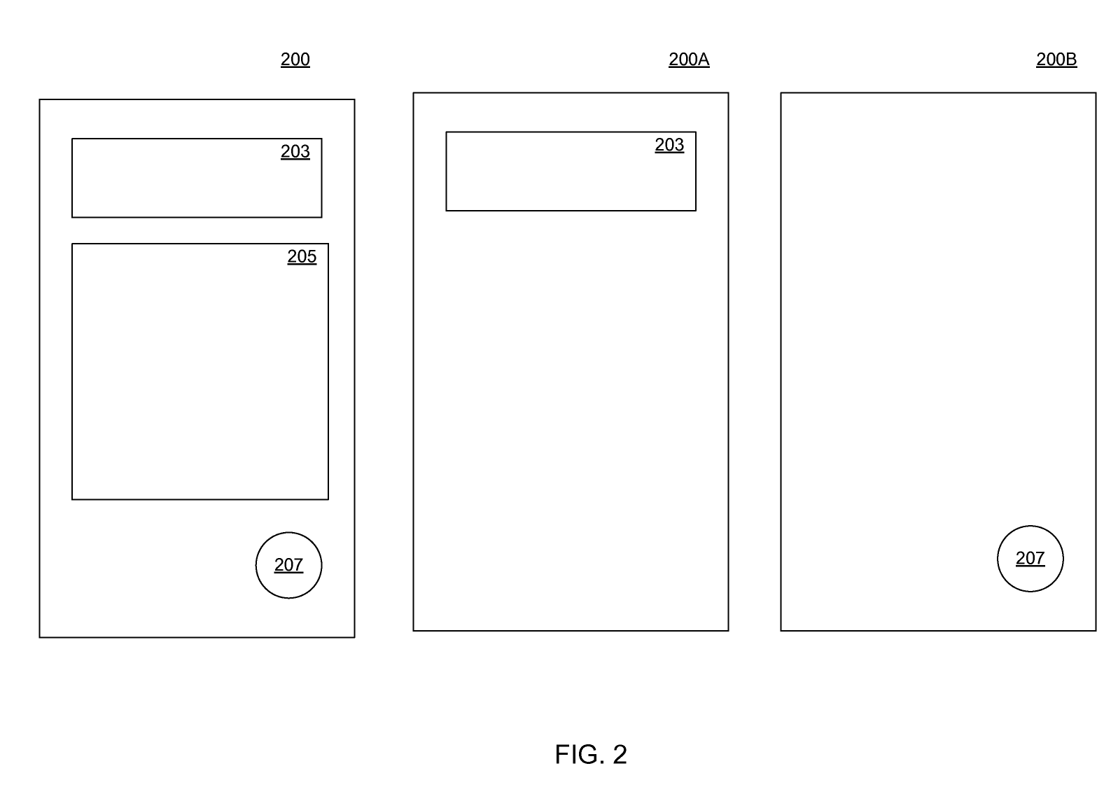

In accordance with one or more aspects of the present disclosure, computer system 100 may acquire a document image and extract one or more color layers from a color map representation of the acquired image. FIG. 2 schematically illustrates an image of a paper document that may be classified in accordance with one or more aspects of the present disclosure. Document image 200 may have a white background and may comprise a red logotype 203, a black text block 205 and a blue seal imprint 207. Each of logotype 203 and seal imprint 207 may comprise certain visual separators and certain text. Red color layer 200A of the document image 200 comprises the image of the logotype 203, and blue color layer 200B of the document image 200 comprises the image of the seal imprint 207.

In an illustrative example, responsive to acquiring the document image, computer system 100 may create a color map representation of the image in the hue-saturation-value (HSV) color space. The HSV color space is produced by transforming the values of the RGB color space into cylindrical coordinates. The angle around the central vertical axis corresponds to “hue” and the distance from the axis corresponds to “saturation”. The height corresponds to a value that is reflective of the perceived luminance in relation to the saturation. [https://en.wikipedia.org/wiki/HSL_and_HSV] In another illustrative example, responsive to acquiring the document image, computer system 100 may create a color map representation of the image in the YC_{B}C_{R} color space, wherein Y represents the luminance value and Cb and Cr represent the blue-difference and red-difference chrominance values, respectively.

Using the color map representation, computer system 100 may then extract one or more color layers from the color map representation of the image. In the illustrative example of FIG. 2, computer system 100 may extract, from color map representation of the document image 200, the red color layer 200A and the blue color layer 200B. The red color layer 200A of the document image 200 may comprise the image of the logotype 203, and the blue color layer 200B of the document image 200 may comprise the image of the seal imprint 207.

Computer system 100 may then use the color layer representation to evaluate a plurality of pre-defined parameters of the image. Examples of such parameters include: presence of one or more certain colors in the image, the ratio of the number of pixels of one or more certain colors to the total number of pixels within the image, the ratio of the image area overlapped by a certain color layer to the total image area, presence of any text in a certain color layer, and/or presence of a certain text in a certain color layer.

In various illustrative example, computer system 100 may also evaluate other pre-defined parameters of the image, including, e.g., relative or absolute positions of text columns and/or text separators, presence or frequency of certain lexemes, presence of certain bar codes or other graphical carriers of encoded information, etc.

Based on the obtained parameter values, computer system 100 may associate the document image with a certain category of a plurality of categories. The classification may include one or more categories reflecting the presence in the document image of one or more pre-defined objects having certain colors. In various illustrative examples, such objects may be represented by an imprint of a certain seal within a certain color layer, a certain text within a certain color layer, or a certain graphical element (such as a letterhead element, a visual separator, a logotype, a watermark, or the like) within the certain color layer.

In certain implementations, computer system 100 may utilize a classification function for identifying the category to be associated with the document image. Values of classification function may reflect the degree of association of the document image with a certain category of the plurality of categories (e.g., the probability of the document image being associated with a certain category). The computer system may evaluate the chosen classification function for each category of the plurality of categories, and then associate the document image with the category corresponding to the optimal (e.g., minimal or maximal) value of the classification function. While in an illustrative example described in more details herein below, the classification function may be provided by a naïve Bayes classifier, other probabilistic or deterministic functions may be employed by the methods described herein.

In an illustrative example, the classification function may be provided by a naïve Bayes classifier:

$$p ( {C}_{k} \vert {F}_{1} , … , {F}_{n} ) = \frac{1}{Z} p ( {C}_{k} ) {\prod }_{i = 1}^{n} p ( {F}_{i} \vert {C}_{k} )$$

Where p(Cₖ|F₁, . . . , Fₙ) is the conditional probability of an object having the parameter values F₁, . . . , Fₙ being associated with the category Cₖ,

P(Cₖ) is the apriori probability of an object being associated with the category Cₖ,

Z is the normalizing constant, and

P(Fᵢ|Cₖ) is the probability of an object having the parameter value Fᵢ being associated with the category Cₖ.

In certain implementations, computer system 100 may, for each category of a plurality of document image classification categories, calculate a value of the chosen classification function (e.g., Bayes naïve classifier) reflecting the probability of the document image being associated with the respective category. Computer system 100 may then select the optimal (e.g., maximal) value among the calculated values, and associate the document image with a category corresponding to the selected optimal value of the classification function.

In certain implementations, the classification function calculation may rely on an evidence data set correlating document image parameters and document image categories. In an illustrative example, the values of P(Cₖ) and P(Fᵢ|Cₖ) are calculated based on the evidence data set.

Computer system 100 may create and/or update the evidence data set by performing a classifier training stage that involves processing a plurality of example images with known classification. For each example image, the computer system may evaluate the image parameters and store the determined parameter values in association with the identifier of the category to which the example image pertains. Alternatively, the computer system implementing the methods described herein may receive the evidence data set from an external source (e.g., from another computer system).

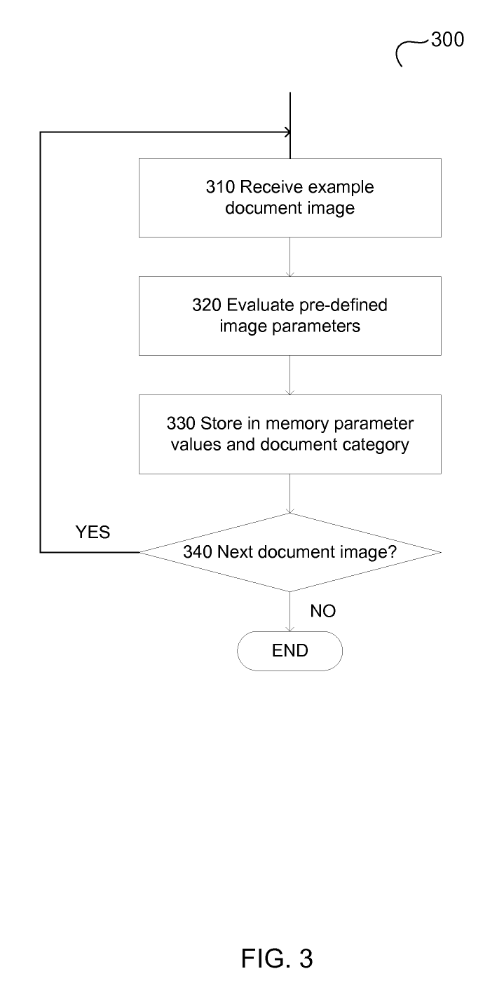

FIG. 3 depicts a flow diagram of one illustrative example of a method 300 for processing example images with known classification for training the classifier, in accordance with one or more aspects of the present disclosure. Method 300 and/or each of its individual functions, routines, subroutines, or operations may be performed by one or more processors of the computer system (e.g., processing device 100 of FIG. 1) executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other.

At block 310, the processing device implementing the method may receive a document image. In an illustrative example, the image may be acquired via an optical input device 160 of example processing device 100 of FIG. 1.

At block 320, the processing device may evaluate a plurality of pre-defined parameters of the example document image. As noted herein above, one or more parameters of the image may be evaluated by extracting one or more color layers from a color map representation of the image (e.g., in HSV color space or an YCbCr color space). Examples of such parameters include: presence of one or more certain colors in the image, the ratio of the number of pixels of one or more certain colors to the total number of pixels within the image, the ratio of the image area overlapped by a certain color layer to the total image area, presence of any text in a certain color layer, and/or presence of a certain text in a certain color layer. Examples of other parameters of the example document image that may be evaluated include: relative or absolute positions of text columns and/or text separators, presence or frequency of certain lexemes, presence of certain bar codes or other graphical carriers of encoded information, etc.

At block 330, the processing device may store the parameter values in association with the image category identifier in a memory, such as a file or a database.

Responsive to determining, at block 340, that another example document image needs to be processed, the method may loop back to acquiring the next example document image at block 310; otherwise, the method may terminate.

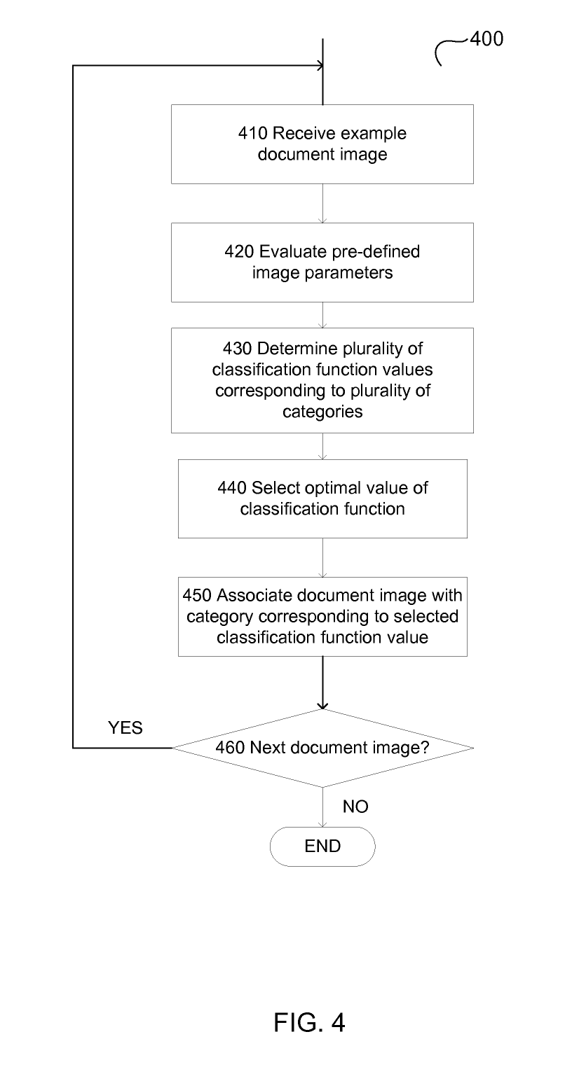

FIG. 4 depicts a flow diagram of one illustrative example of a method 400 for document image classification, in accordance with one or more aspects of the present disclosure. Method 400 and/or each of its individual functions, routines, subroutines, or operations may be performed by one or more processors of the computer system (e.g., processing device 100 of FIG. 1) executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other.

At block 410, the processing device implementing the method may receive a document image. In an illustrative example, the image may be acquired via an optical input device 160 of example processing device 100 of FIG. 1.

At block 420, the processing device may evaluate a plurality of pre-defined parameters of the document image. As noted herein above, one or more parameters of the image may be evaluated by extracting one or more color layers from a color map representation of the image (e.g., in HSV color space or an YCbCr color space). Examples of such parameters include: presence of one or more certain colors in the image, the ratio of the number of pixels of one or more certain colors to the total number of pixels within the image, the ratio of the image area overlapped by a certain color layer to the total image area, presence of any text in a certain color layer, and/or presence of a certain text in a certain color layer. Examples of other parameters of the document image that may be evaluated include: relative or absolute positions of text columns and/or text separators, presence or frequency of certain lexemes, presence of certain bar codes or other graphical carriers of encoded information, etc.

At block 430, the processing device may determine a plurality of values of a chosen classification function. Each value of the classification function may reflect the probability of the document image being associated with a certain category of the plurality of categories. In certain implementations, the classification function may be provided by a naïve Bayes classifier, as described in more details herein above.

At block 440, the processing device may select an optimal value of the classification function among the determined plurality of values.

At block 450, the processing device may associate the document image with a category corresponding to the selected optimal value of the classification function.

Responsive to determining, at block 460, that another document image needs to be processed, the method may loop back to acquiring the next document image at block 410; otherwise, the method may terminate.

FIG. 5 illustrates a more detailed diagram of an example computer system 1000 within which a set of instructions, for causing the computer system to perform any one or more of the methods discussed herein, may be executed. The computer system 1000 may include the same components as computer system 100 of FIG. 1, as well as some additional or different components, some of which may be optional and not necessary to provide aspects of the present disclosure. The computer system may be connected to other computer system in a LAN, an intranet, an extranet, or the Internet. The computer system may operate in the capacity of a server or a client computer system in client-server network environment, or as a peer computer system in a peer-to-peer (or distributed) network environment. The computer system may be a provided by a personal computer (PC), a tablet PC, a set-top box (STB), a Personal Digital Assistant (PDA), a cellular telephone, or any computer system capable of executing a set of instructions (sequential or otherwise) that specify operations to be performed by that computer system. Further, while only a single computer system is illustrated, the term “computer system” shall also be taken to include any collection of computer systems that individually or jointly execute a set (or multiple sets) of instructions to perform any one or more of the methodologies discussed herein.

Exemplary computer system 1000 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 526 for performing the operations and functions discussed herein.

Computer system 1000 may further include a network interface device 522, a video display unit 510, a character input device 512 (e.g., a keyboard), and a touch screen input device 514.

Data storage device 518 may include a computer-readable storage medium 524 on which is stored one or more sets of instructions 526 embodying any one or more of the methodologies or functions described herein. Instructions 526 may also reside, completely or at least partially, within main memory 504 and/or within processor 502 during execution thereof by computer system 1000, main memory 504 and processor 502 also constituting computer-readable storage media. Instructions 526 may further be transmitted or received over network 516 via network interface device 522.

In certain implementations, instructions 526 may include instructions of application 190 for classifying document images using color layer information, and may be performed by application 190 of FIG. 1. While computer-readable storage medium 524 is shown in the example of FIG. 5 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computer system, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a processing device, a document image;
determining values of one or more parameters of the document image, wherein at least one parameter is evaluated by extracting one or more color layers of the document image; and
associating, based on the values of the parameters, the document image with a category of a plurality of categories.

2. The method of claim 1, wherein the parameters comprise at least one parameter from a group consisting of: a binary parameter and a range parameter.

3. The method of claim 1, wherein at least one parameter comprises at least one of: presence of one or more certain colors in the document image, a ratio of a number of pixels of one or more certain colors to a total number of pixels within the document image, a ratio of a document image area overlapped by a certain color layer to a total document image area, presence of any text in a certain color layer, or presence of a certain text in a certain color layer.

4. The method of claim 1, further comprising:
receiving an example document image associated with a certain category;
determining values of the parameters of the example document image; and
storing, in a memory, the determined values in association with an identifier of the certain category.

5. The method of claim 1, wherein associating the document image with a category of a plurality of categories comprises:
determining a plurality of values of a classification function, each value of the classification function reflecting probability of the document image being associated with a certain category of the plurality of categories;
selecting an optimal value of the classification function among the determined plurality of values; and
associating the document image with a category corresponding to the selected optimal value of the classification function.

6. The method of claim 5, wherein the classification function is provided by a naïve Bayes classifier.

7. The method of claim 5, wherein determining the plurality of values of the classification function comprises retrieving, from a memory, values of the parameters of a plurality of example document images associated with the plurality of categories.

8. The method of claim 1, wherein extracting the color layers is performed using a color map representation of the document image using at least one of: an HSV color space or an YCbCr color space.

9. The method of claim 8, wherein the color map representation comprises a plurality of color values corresponding to a plurality of pixels comprised by the document image.

10. The method of claim 1, wherein evaluating the parameter comprises performing a document layout analysis (DA) of the extracted color layer of the document image.

11. The method of claim 1, wherein evaluating the parameter comprises performing an optical character recognition (OCR) of the extracted color layer of the document image.

12. The method of claim 1, wherein the plurality of categories comprises a category associated with presence in the document image of a certain object having one or more certain colors.

13. The method of claim 12, wherein the object comprises at least one of: an imprint of a certain seal, a text, a certain text, or a certain graphical element.

14. A system, comprising:
a memory;
a processing device, coupled to the memory, the processing device configured to:
receive, by a processing device, a document image;
determine values of one or more parameters of the document image, wherein at least one parameter is evaluated by extracting one or more color layers of the document image; and
associate, based on the values of the parameters, the document image with a category of a plurality of categories.

15. The system of claim 14, wherein at least one parameter comprises at least one of: presence of one or more certain colors in the document image, a ratio of a number of pixels of one or more certain colors to a total number of pixels within the document image, a ratio of a document image area overlapped by a certain color layer to a total document image area, presence of any text in a certain color layer, or presence of a certain text in a certain color layer.

16. The system of claim 14, wherein the processing device is further configured to:
receive an example document image associated with a certain category;
determine values of the parameters of the example document image; and
store, in a memory, the determined values in association with an identifier of the certain category.

17. The system of claim 14, wherein associating the document image with a category of a plurality of categories comprises:
determining a plurality of values of a classification function, each value of the classification function reflecting probability of the document image being associated with a certain category of the plurality of categories;
selecting an optimal value of the classification function among the determined plurality of values; and
associating the document image with a category corresponding to the selected optimal value of the classification function.

18. A computer-readable non-transitory storage medium comprising executable instructions that, when executed by a processing device, cause the processing device to perform operations comprising:
receiving a document image;
determining values of one or more parameters of the document image, wherein at least one parameter is evaluated by extracting one or more color layers of the document image; and
associating, based on the values of the parameters, the document image with a category of a plurality of categories.

19. The computer-readable non-transitory storage medium of claim 18, wherein at least one parameter comprises at least one of: presence of one or more certain colors in the document image, a ratio of a number of pixels of one or more certain colors to a total number of pixels within the document image, a ratio of a document image area overlapped by a certain color layer to a total document image area, presence of any text in a certain color layer, or presence of a certain text in a certain color layer.

20. The computer-readable non-transitory storage medium of claim 18, further comprising executable instructions causing the processing device to:
receive an example document image associated with a certain category;
determine values of the parameters of the example document image; and
store, in a memory, the determined values in association with an identifier of the certain category.

21. The computer-readable non-transitory storage medium of claim 18, wherein associating the document image with a category of a plurality of categories comprises:
determining a plurality of values of a classification function, each value of the classification function reflecting probability of the document image being associated with a certain category of the plurality of categories;
selecting an optimal value of the classification function among the determined plurality of values; and associating the document image with a category corresponding to the selected optimal value of the classification function.
